(19) United States
(12) Patent Application Publication
(10) Pub. No.: US 2025/0209529 A1
(43) Pub. Date: Jun. 26, 2025

(54) COMPUTING SYSTEM TO PROACTIVELY GENERATE REFINANCE OFFERS

(71) Applicant: Wells Fargo Bank, N.A., San Francisco, CA (US)

(72) Inventor: Badrinath Vengalathur Srinath, Fremont, CA (US)

(21) Appl. No.: 18/392,951

(22) Filed: Dec. 21, 2023

(51) Int. Cl. G06Q 40/03

(52) U.S. Cl. CPC G06Q 40/03

(57) ABSTRACT

A computing system is configured to periodically obtain data associated with a current state of a current loan on a secured property of a user. The computing system determines, using one or more data models, a predicted refinance rate for the secured property and an associated confidence score. The computing system determines whether to present an offer for a refinanced loan on the secured property at the predicted refinance rate to the user based on a determination of an advantage of the refinanced loan over the current loan on the secured property. The computing system generates and sends a message including an indication of the offer for the refinanced loan to a user device of the user. The computing system receives a user response to the offer for the refinanced loan and updates the one or more data models based on the user response to the offer.

### TECHNICAL FIELD

This disclosure relates to computing systems that generate refinance offers.

### BACKGROUND

Mortgages are loans secured by property, such as houses or commercial property. Based on general changes of interest rates or growth of equity in the underlying property, refinancing of the mortgage at a better interest rate may become available. Typically, to get a refinance offer for a property, the owner provides information about personal finances, such as income, debt, and credit score to the new lender. Once an institution approves the owner for a refinance loan, the original loan may be paid off and the owner then makes mortgage payments on the new mortgage.

### SUMMARY

This disclosure is directed to techniques for proactively generating a refinance offer for a secured property of a user based on data associated with a current state of a current loan on the secured property. The secured property may be any property used as collateral for the loan and which appreciates in value over time. According to the techniques, a computing system periodically obtains data from various databases, including user information, current loan information, current interest rates, and current property estimates, and applies that data as input to one or more data models, e.g., statistical models and/or machine learning models, to automatically determine a predicted refinance rate for the secured property. The computing system then determines whether to present an offer for a refinanced loan on the secured property at the predicted refinance rate to the user based on an associated confidence score of the predicted refinance rate and a determination of an advantage of the refinanced loan over the current loan on the secured property.

According to the disclosed techniques, the computing system may generate the offer for the refinanced loan proactively before the user may even be considering refinancing the current loan on the secured property. For example, instead of waiting for the user to initiate refinancing of a current mortgage, the computing system may proactively identify the current mortgage as a candidate for refinancing and automatically offer a new, more advantages mortgage to the user. In scenarios where the computing system is used by a financial or lending institution that holds the current loan on the secured property, the disclosed techniques may improve retention of loan customers with the financial or lending institution by proactively offering the refinanced loan before the user requests or receives competing offers from other institutions.

In some examples, the computing system may use one or more machine learning models to generate a predicted refinance interest rate for the secured property and an associated confidence score that the predicted refinance rate is accurate. In some examples, the machine learning models may also generate a risk value, a potential loan amount, and/or potential restrictions to the offer such as required inspection reports, as well as associated confidence scores. The computing system may then analyze the predicted refinance rate based on the associated confidence score, and in relation to the current loan on the secured property, to determine whether to provide an offer to the user for a refinanced loan on the secured property at the predicted refinance rate. For example, the computing system may present the offer to the user if the predicted refinance interest rate is better (e.g., lower) than the current mortgage interest rate for the secured property by more than a threshold value.

The computing system may comprise or by included in an interconnected network of computing systems, e.g., within an enterprise network of an institution. The interconnected network may allow the computing system to access or otherwise obtain data associated with the user and the current loan on the secured property from multiple data repositories, both internal to the institution as well as commercial databases, which enable the machine learning models to accurately predict refinance rate for the secured property of the user. The computing system may then automatically message the user to present an offer for a refinanced loan with the predicted refinance rate. The computing system may re-train or otherwise update the machine learning models based on user responses (e.g., acceptance or rejection/non-acceptance of offers) and web analytics (e.g., user interaction with the offer messages).

In some examples, this disclosure is directed to a method comprising periodically obtaining, by a computing system, data associated with a current state of a current loan on a secured property of a user; in response to obtaining the data, determining, by the computing system using one or more data models and based on the data associated with the current state of the current loan, a predicted refinance rate for the secured property and an associated confidence score that the predicted refinance rate is accurate; determining whether to present an offer for a refinanced loan on the secured property at the predicted refinance rate to the user based on the associated confidence score and a determination of an advantage of the refinanced loan over the current loan on the secured property; based on determining to present the offer for the refinanced loan to the user, generating and sending a message including an indication of the offer for the refinanced loan with the predicted refinance rate to a user device of the user; receiving a user response to the offer for the refinanced loan; and updating the one or more data models based on the user response to the offer.

In other examples, this disclosure is directed to a computing system comprising one or more memories and processing circuitry in communication with the one or more memories. The processing circuitry is configured to periodically obtain data associated with a current state of a current loan on a secured property of a user; in response to obtaining the data, determine, using one or more data models and based on the data associated with the current state of the current loan, a predicted refinance rate for the secured property and an associated confidence score that the predicted refinance rate is accurate; determine whether to present an offer for a refinanced loan on the secured property at the predicted refinance rate to the user based on the associated confidence score and a determination of an advantage of the refinanced loan over the current loan on the secured property; based on determining to present the offer for the refinanced loan to the user, generate and send a message including an indication of the offer for the refinanced loan with the predicted refinance rate to a user device of the user; receive a user response to the offer for the refinanced loan; and update the one or more data models based on the user response to the offer.

In further examples, this disclosure is directed to a non-transitory computer-readable storage medium comprising instructions that, when executed, cause processing circuitry to periodically obtain data associated with a current state of a current loan on a secured property of a user; in response to obtaining the data, determine, using one or more data models and based on the data associated with the current state of the current loan, a predicted refinance rate for the secured property and an associated confidence score that the predicted refinance rate is accurate; determine whether to present an offer for a refinanced loan on the secured property at the predicted refinance rate to the user based on the associated confidence score and a determination of an advantage of the refinanced loan over the current loan on the secured property; based on determining to present the offer for the refinanced loan to the user, generate and send a message including an indication of the offer for the refinanced loan with the predicted refinance rate to a user device of the user; receive a user response to the offer for the refinanced loan; and update the one or more data models based on the user response to the offer.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example enterprise network including computing systems configured to proactively generate refinance offers for secured properties, in accordance with one or more aspects of the present disclosure.

FIG. 2 is a block diagram illustrating an example computing system configured to predict refinance rates for secured properties, in accordance with one or more aspects of the present disclosure.

FIG. 3 is a block diagram illustrating an example computing system configured to generate offers for refinanced loans on secured properties, in accordance with one or more aspects of the present disclosure.

FIG. 4 is a conceptual diagram illustrating an example operation of predicting refinance rates for secured properties using machine learning models and generating offers for refinanced loans on the secured properties, in accordance with one or more aspects of the present disclosure.

FIG. 5 is a flow diagram illustrating an example operation of proactively generating refinance offers for secured properties, in accordance with one or more aspects of the present disclosure.

### DETAILED DESCRIPTION

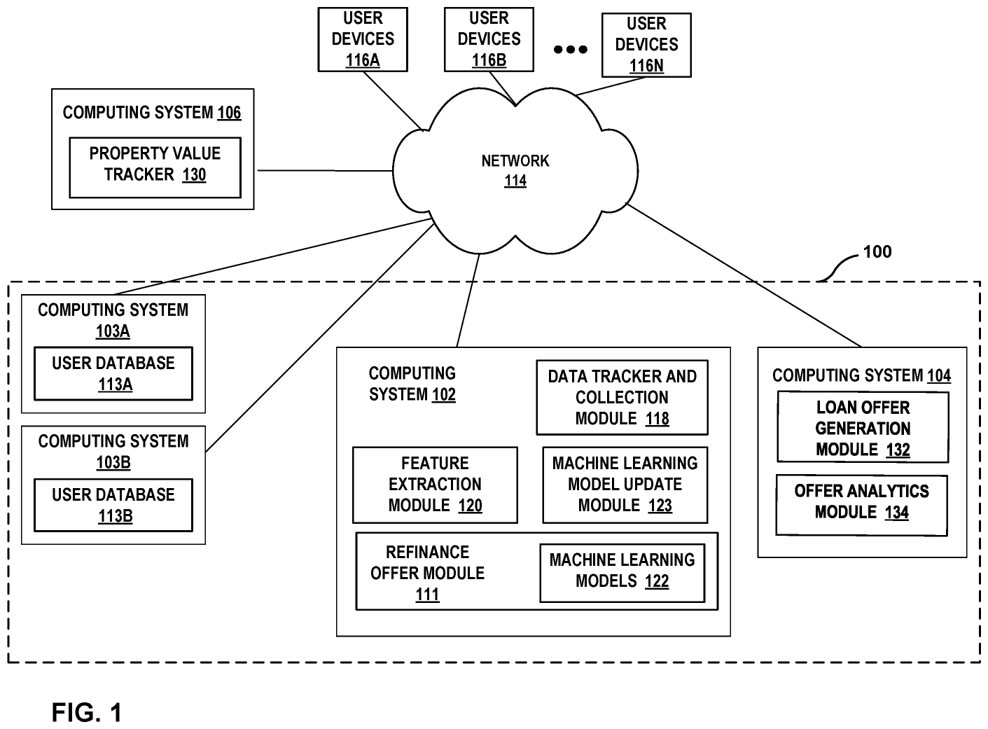

FIG. 1 is a block diagram illustrating an example network system including an enterprise network 100 including computing systems 102, 104 configured to proactively generate refinance offers for secured properties of users, in accordance with one or more aspects of the present disclosure. In this example, enterprise system 100 may comprise an interconnected network of computing systems of a financial or lending institution. In the illustrated example of FIG. 1, computing system 102 is configured to predict refinance rates for secured properties based on user data retrieved from computing systems 103A and 103 (collectively, “computing system 103”) within enterprise network 100 and property data retrieved from computing system 106 external to enterprise network 100 via network 114. In addition, computing system 104 is configured to generate offers for refinanced loans on the secured properties at the predicted refinance rates for presentation to the users via user device 116A-116N (collectively, “user devices 116) via network 114. According to the disclosed techniques, computing systems 102, 104 may generate a refinanced loan offer for a secured property of a user before the user may even be considering refinancing a current loan on the secured property, and before the user requests or receives competing offers from other financial or lending institutions for a refinanced loan.

In the example of FIG. 1, computing systems 102, 103, 104 of enterprise network 100 are illustrated as stand-alone computing systems connected via external network 114. In other examples, one or more of computing systems 102, 103, 104 may be directly interconnected via physical cables and/or interconnected via a private network (not shown), e.g., an intranet. In various examples, each of computing systems 102, 103, 104 may comprise multiple computing devices and be implemented at one or more data centers with multiple computing devices. In the example illustrated in FIG. 1, computing system 102 includes refinance offer module 111, data tracker and collection module 118, features extraction module 120, and machine learning model update module 123; computing system 104 includes a loan offer generation module 132 and an offer analytics module 134; and computing systems 103 include user databases 113A-113B, respectively. In various other examples, the operations and storage associated with computing system 102, computing systems 103, and/or computing system 104 may be performed by other computing systems within enterprise network 100. In some examples, the operations of computing system 102 and computing system 104 may be performed by a single computing system or more than two computing systems. Similarly, the user database 113A, 113B maintained by computing systems 103 may be maintained within a single computing system or across more than two computing systems.

Network 114 illustrated in FIG. 1 may include or represent any public or private communications network, or other type of network. Although illustrated in FIG. 1 as a single network, in other examples network 114 may comprise any number of networks and may be a subnetwork of another network. For example, network 114 may be two or more of such networks combined into a single network. In various examples, one or more of such networks may be, or may be part of, the Internet. One or more client devices, server devices, or other computing systems may transmit and receive data, commands, control signals, and/or other information across such networks using any suitable communication techniques. Accordingly, one or more of the devices or systems illustrated in FIG. 1, e.g., user devices 116, computing systems 102, 103, 104, 106, may be in a remote location relative to one or more other illustrated devices or systems, but nevertheless be capable of transmitting and receiving data, commands, control signals, and/or other information with the one or more other illustrated devices or systems via network 114. Network 114 illustrated in FIG. 1 may include one or more network hubs, network switches, network routers, network links, satellite dishes, or any other network equipment. Such devices or components may be operatively inter-coupled, thereby providing for the exchange of information between computers, devices, or other components (e.g., between one or more user devices or systems, and one or more server devices or systems).

In the illustrated example of FIG. 1, computing systems 102 and 104 within enterprise network 100 of a financial or lending institution may be configured to proactively generate refinance offers to users (e.g., customers) who have a current loan (e.g., a mortgage) on a secured property (e.g., a house or other real property) at a financial or lending institution. The secured property may be any property used as collateral for the loan and which appreciates in value over time, such as real property (e.g., land, permanent structures or buildings, permanent improvements or fixtures) and certain appreciable material goods.

Computing systems 102, 104 may present a refinance offer to a user via one of user devices 116 before any requests from the user have been received by the institution. For example, computing systems 102 and 104 may periodically obtain data associated with a current state of a current loan of the user stored at user databases 113 of computing systems 103 within enterprise network 100 and property value tracker 130 of computing system 106 external to enterprise network 100. Instead of waiting for the user to initiate a loan refinance request (e.g., via a mobile application, website, telephone call, or in-person) for the secured property, computing system 102 may determine, based on the data associated with the current state of the current loan, a predicted refinance rate for the secured property, and determine whether to present an offer for a refinanced loan on the secured property at the predicted refinance rate to the user. Based on a determination to present the offer for the refinanced loan to the user, computing system 104 generates and sends a message including an indication of the offer for the refinanced loan with the predicted refinance rate to the user via the one of user devices 116.

As illustrated and described with reference to FIG. 1, the computing system 102 may include data tracker and collection module 118, which may obtain data from several internal systems of enterprise network 100, such as computing systems 103A and 103B, which are illustrated as including user databases 113A and 113B respectively. Data tracker and collection module 118 of computing system 102 may also obtain data from several external systems, such a computing system 106, which is illustrated in FIG. 1 as including property value tracker 130. Computing system 102 may periodically obtain data associated with the current state of the current loan on a secured property of a user. Data tracker and collection module 118 may obtain the data on a fixed schedule, such as once a day, once a week, or once a month.

Data stored in user databases 113 at computing systems 103 may include details concerning the user and the user's relationship with the institution, as well as details concerning one or more current loans on secured properties of the user. For example, the data stored in user databases 113 at computing systems 103 may include addresses or other location information of the secured properties, the current loan amounts, the current loan rates. In addition, the data stored in user databases 113 may also include data related to the user's relationship with the institution, such as additional owned properties, additional loans, length of relationship with the institution, creditworthiness, and account information such as savings and checking accounts. In some examples, computing system 102 may also obtain or have access to general interest rate related information, such as mortgage rates, prime rates, federal funds rates, or costs of funds from sources, e.g., computing systems 103, within enterprise network 100 or sources, e.g., computing system 106, external to enterprise network 100.

Property value tracker 130 included in computing system 106 external to enterprise network 100 may be a website that uses an algorithm based on information such as local building sales, number of bedrooms, square feet, and other information to produce property value estimates. In some examples, property value tracker 130 may expose an application programming interface (API) that allows computing system 102 to obtain an estimate of a current property value of a property at a given address. In other examples, computing system 102 may access a uniform resource locator (URL) provided by property value tracker 130 for each property in order to obtain the current property value of the property. In order to predict refinance rate for the secured property, computing system 102 may periodically query property value tracker 130 at computing system 106, e.g., via an API or URL, to obtain the current property value of the secured property.

Data tracker and collection module 118 of computing system 102 may track, obtain input data, and associate at least some input data from multiple computing systems, such as computing systems 103 and/or computing system 106, with a unique global user identifier and/or a unique property identifier. For example, data associated with all mortgaged properties of the user, such as building addresses, loan documents, and valuations of the properties, may be associated with the unique user identifier. Data associated with each of the mortgaged properties of the user, such as a building address, loan documents, and valuations for the respective property, may be associated with the unique property identifier.

Data tracker and collection module 118 of computing system 102 may interface with other computing systems, such as internal computing systems 103A and 103B including user databases 113A and 113B as well as external computing systems 106 including property value tracker 130, to obtain the data associated with the current state of the current loan on the secured property and used to predict and present a refinance offer for the secured property. Data tracker and collection module 118 may associate a unique global user identifier with local user identifiers used at multiple data repositories, such as user database 113A of computing system 103A and user database 113B of computing system 103B. After computing system 102 obtains the data associated with the current state of the current loan on the secured property from the multiple data repositories 113, 130, data tracker and collection module 118 may associate and store the data using the unique global user identifier. For example, a user may be associated with a different local identifier at user database 113A of computing system 103A than at user database 113B of computing system 103B. The global user identifier may associate the local identifiers from user databases 113A, 113B with the single, unique global user identifier of the user. For example, computing system 102 may obtain data from user databases 113A, 113B of computing systems 103A, 103B using the appropriate local identifier which is associated with the global user identifier. In one example, data tracker and collection module 118 of computing system 102 may query user databases 113A, 113B of computing systems 103A, 103B, respectively, using the appropriate local identifier.

Feature extraction module 120 of computing system 102 may process the data associated with the current state of the current loan on the secured property for use by data models, such as one or more machine learning models 122 of refinance offer module 111 of computing system 102. Feature extraction module 120 may transform the data into a set of features used for training and operation of machine learning models 122. Feature extraction module 120 may clean and preprocess the data by handling missing values, outliers, and data normalization and ensure that the data is in a format suitable for training and operating a machine learning model, such as normalized into a range from 0 to 1.

Refinance offer module 111 of computing system 102 may determine, using one or more data models, such as one or more of machine learning model 122, and based on the transformed data associated with the current state of the current loan on the secured property, a predicted refinance rate for the secured property and an associated confidence score that the predicted refinance rate is accurate. Confidence score may indicate a level of certainty or trust that a data model has in its predictions or classifications. Confidence scores may be numerical values in the range of 0 to 1 with low scores indicating low certainty and high scores indicating higher certainty. As discussed below, refinance offer module 111 of computing system 102 and/or loan offer generation module 132 of computing system 104 may use confidence scores compared against a threshold to determine whether to present an offer for a refinanced loan on the secured property at the predicted refinance rate to the user. For example, loan offer generation module 132 of computing system 104 may avoid presenting an offer at the predicted refinance rate when the confidence score associated with the predicted refinance rate is below the threshold.

Refinance offer module 111 of computing system 102 may apply the transformed data associated with the current state of the current loan on the secured property from feature extraction module 120 as input to one of machine learning models 122, and determine as output of the one of machine learning models 122, the predicted refinance rate for the secured property. In some examples, the inputs to the one of machine learning models 122 used to determine the predicted refinance rate of the secured property may include a federal funds rate or a prime rate as well as the estimated value of the secured property, outstanding balance on the current loan, and creditworthiness of the user. In one example, the one of machine learning model 122 may determine a delta to the federal funds rate or the prime rate based on the estimated value of the secured property, outstanding balance on the current loan, and creditworthiness of the user and add this delta to the federal funds rate or the prime rate to determine the predicted refinance rate for the secured property.

In some examples, refinance offer module 111 may apply the transformed data associated with the current state of the current loan on the secured property from feature extraction module 120 as input to multiple machine learning models 122. As one example, financial offer module 111 may use another one of machine learning models 122 to determine a predicted risk and an associated risk confidence score that the predicted risk is accurate. The predicted risk may be a prediction of how risky a refinanced loan at the predicted refinance rate would be for the financial or lending institution. The predicted risk may be a range value, such as from 0 to 1, or may be a categorical value, such as “low”, “medium” or “high”. In some examples, the inputs to the another one of machine learning models 122 used to determine the predicted risk of a refinanced loan at the predicted refinance rate may include creditworthiness of the user, base interest rates, the estimated value of the secured property, and the outstanding balance on the current loan.

As another example, refinance offer module 111 may use another one of machine learning models 122 to determine a predicted refinanced loan amount and an associated refinanced loan amount confidence score that the predicted refinanced loan amount is accurate. The predicted refinanced loan amount may be a prediction of a monetary amount of a refinanced loan that the financial or lending institution would offer at the predicted refinance rate. In some examples, the inputs to the another one of machine learning models 122 used to determine the predicted refinanced loan amount at the predicted refinance rate may include the estimated value of the secured property and the outstanding balance on the current loan.

In some examples, one or more of machine learning models 122 may determine one or more offer restrictions associated with the predicted refinance rate for the secured property (and any subsequent offer for a refinanced loan on the secured property at the predicted refinance rate). For example, an offer restriction may be an inspection restriction such as a requirement that the user has, and in some cases successfully pass, a roof inspection on the secured property in order to qualify for the refinanced loan at the predicted refinance rate. In some examples, the inputs to machine learning models 122 used to determine offer restrictions associated with the predicted refinance rate may include the estimated value of the secured property and outstanding balance on the current loan.

Computing system 102, or another computing system of enterprise network 100, may train each of machine learning models 122 using historical data including inputs such as interest rates, property values, user information, refinance offer acceptance rates, and profitability of refinance offers made in the past. Machine learning models 122 may trained from algorithms used for time series forecasting and regression tasks such as linear regression, decision trees, random forests, support vector machines, and more advanced methods like neural networks. Computing system 102 may tune parameters of each of machine learning models 122 based on testing or validation performed after the training process and/or based on user feedback on output from the models to optimize model performance.

In the illustrated example of enterprise network 100 in FIG. 1, computing system 102 may transmit at least the predicted refinance rate for the secured property of the user and the associated confidence score to computing system 104 either directly or via network 114. In some examples, computing system 102 may also transmit a predicted risk, a predicted refinance loan amount, and/or one or more offer restrictions associated with the secured property and the predicted refinance rate to computing system 104, along with associated confidence scores.

Offer analytics module 134 of computing system 104 may analyze the output of machine learning models 122 of computing system 102. Offer analytics module 134 of computing system 104 determines whether to present an offer for a refinanced loan on the secured property at the predicted refinance rate to the user based on at least the predicted refinance rate and the confidence score associated with the predicted refinance rate. More specifically, offer analytics module 134 may determine an advantage of the refinanced loan over the current loan on the secured property. For example, if the predicted refinance rate is lower than a current interest rate of the current loan on the secured property by more than a threshold value, offer analytics module 134 of computing system 104 may determine to present an offer for the refinanced loan on the secured property at the predicted refinance rate to the user. In some examples, offer analytics module 134 may also use a predicted risk and/or a predicted refinance loan amount for the refinanced loan at the predicted refinance rate to determine the advantage of the refinanced loan over the current loan on the secured property.

An administrator of enterprise network 100 may interact with computing system 104 via a user interface (not shown in FIG. 1) to set or select thresholds for offer analytics module 134 to determine the advantage of a refinanced loan with respect to a current loan on a secured property. Exemplary rules may be, for example, “current interest rate−rate threshold>predicted refinance rate,” “predicted risk<risk threshold,” “predicted refinance loan amount=>outstanding balance on the current loan,” or “confidence score>accuracy threshold.” If the rules are satisfied, offer analytics module 134 may determine to present the offer for the refinanced loan to the user.

Offer generation module 132 of computing device 104 may, based on a determination to present the offer for the refinanced loan to the user, generate and send a message including an indication of the offer for the refinanced loan with the predicted refinance rate to one of user devices 116 associated with the user. The generated message may also include indications of any offer restrictions associated with the secured property and the predicted refinance rate, which the user must fulfill in order to be eligible for the refinanced loan at the predicted refinance rate. For example, the offer restriction may be an inspection restriction such as a requirement for the user to have a roof inspection performed on the secured property, and in some cases successfully passed, in order to qualify for the predicted refinance rate. In one example, the message indicating the offer may include one refinance rate for the secured property without any offer restrictions and a lower refinance rate for the secured property if a roof inspection restriction is successfully completed.

In some examples, a human administrator, loan officer, or underwriter associated with the financial or lending institution of enterprise network 100 may first review the offer for the refinanced loan on the secured property at the predicted refinance rate generated by offer generation module 132. The human administrator, loan officer, or underwriter may then authorize the refinanced loan prior to offer generation module 132 sending the message including the indication of the authorized offer to the one of user devices 116 of the user.

In some examples, the offer for the refinanced loan may include waived fees (including an appraisal) or have a slightly better than market interest rate due to reduced loan expenses since the financial or lending institution has substantial knowledge of the property and the user (e.g., through the data obtained from user databases 113 of computing systems 103 and/or property value tracker 130 of computing system 106).

Computing system 102 or computing system 104 may receive a user response to the offer for the refinanced loan. In some examples, loan offer generation module 132 may generate data representative of a user interface (UI) or other interactive feature associated with the message including the indication of the offer for the refinance loan as a means by which the user can accept the offer via the one of user devices 116. Alternately, the user may call, send an email, or otherwise communicate acceptance of the offer. Computing system 102 or computing system 104 may receive an indication of the acceptance of the offer directly from the one of user devices 116 or indirectly from another computing system.

Loan offer generation module 132 of computing system 104 may determine that the offer is not accepted if an explicit rejection is received from the one of user devices 116 or if no response is received after a period of time. Loan offer generation module 132 of computing system 104 may associate each offer with an offer ID which is associated with a user ID, such as the global user ID. Loan offer generation module 132 of computing system 104 may label data of presented offers as accepted or rejected to produce labeled data. In some examples, computing system 104 may use the labeled data to update or refine the thresholds or other rules used by offer analytics module 134 to determine whether to present an offer. In other examples, computing system 104 may transmit the labeled data to computing system 102 for use by machine learning model update module 123 of computing system 102 to update the one or more machine learning models 122. The labeled data for the offer may be included in historical data used to retrain one or more of machine learning models 122. For example, machine learning model update module 123 may retrain parameters of machine learning models 122 based on the labeled data for the offer.

In some examples, in addition to user feedback in the form of user acceptance or rejection of the refinanced loan offer, computing system 102 or computing system 104 may obtain web analytics related to user interaction with the message generated by loan offer generation module 132 indicating the offer for the refinanced loan. For example, in scenarios where the message includes a link or other interactive component by which the user can view, accept, or reject the offer, e.g., a website, loan offer generation module 132 may monitor or receive web analytics indicative of the behavior of the user in opening the message and visiting the website. For example, loan offer generation module 132 may use methods such as tracking, reviewing, and reporting data to measure web activity such as clicks and mouse movements. Computing system 104 may use the web analytics to update or refine the thresholds or other rules used by offer analytics module 134 to determine whether to present an offer. In other examples, computing system 104 may transmit the web analytics to computing system 102 for use by machine learning model update module 123 of computing system 102 to update the one or more machine learning models 122. For example, web analytics related to user interest in the offer may include user clicks or other user interactions with the offer message. In one example, offers that do not receive interest from users based on web analytics may result in retraining to reduce the number of similar offers presented to user in the future.

Computing system 102 may periodically obtain data related to a large corpus of properties. For example, computing system 102 may periodically analyze all or a portion of the properties for which the financial or lending institution of enterprise network 100 holds current loans. In one example, data tracker and collection module 118 computing system 102 may periodically obtain data associated with current states of current loans on multiple secured properties. In response to obtaining the data, refinance offer module 111 of computing system 102 may determine, using one or more machine learning models 122 and based on the data, predicted refinance rates for the multiple secured properties and associated confidence scores that the predicted refinance rates are accurate. Offer analytics module 134 of computing system 104 may determine whether to present one or more offers for refinanced loans on one or more of the multiple secured properties based on the associated confidence scores and a determination of an advantage of the refinanced loans over current loans on the one or more of the multiple secured properties. Based on determining to present the one or more offers, loan offer generation module 132 of computing system 104 may generate and send messages including the one or more offers to one or more of user devices 116.

The techniques of this disclosure provide one or more technical advantages and practical applications. Computing systems 102, 104 may proactively generate refinance offers for secured properties of users and present the refinance offers to the users before the users request refinance offers, which is an improvement to conventional systems that rely on requests from users before providing refinance offers. Further, computing systems 102, 104 may combine user data from multiple data repositories as well as commercial databases to enable a data model, such as one of machine learning models 122, to accurately predict refinance rates for the secured properties. Computing systems 102, 104 may then automatically generate messages indicating the refinance offers and send the messages to user devices 116 of the users. Computing systems 102, 104 may receive user feedback, such as accepted/non-accepted of the offers as well as web analytics, such as user interaction data with the offer messages, to update rules and/or parameters used by computing system 102, 104, such as refining thresholds of offer analytics module 134 or retraining model parameters of machine learning models 122 to increase accuracy of predicted refinance rates and offer presentation determinations.

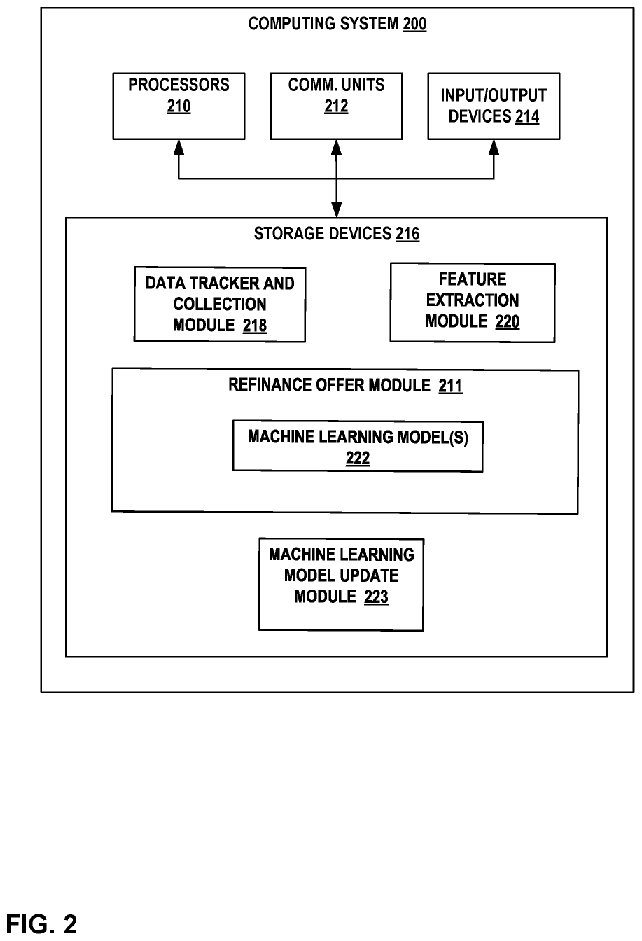

FIG. 2 is a block diagram illustrating an example computing system 200 system configured to predict refinance rates for secured properties, in accordance with one or more aspects of the present disclosure. Computing system 200 may generally correspond to computing system 102 of FIG. 1. Accordingly, the modules of FIG. 2 may perform some or all of the same functions described as being performed by the modules of computing system 102 of FIG. 1.

Computing system 200 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 200 may comprise a server within a data center, cloud computing system, server farm, and/or server cluster (or portion thereof) that provides services to client devices and other devices or systems. For example, computing system 200 may host or provide access to services provided by one or more applications and/or modules running on computing system 200.

Although computing system 200 of FIG. 2 is illustrated as a stand-alone device, in other examples computing system 200 may be implemented in any of a wide variety of ways, and may be implemented using multiple devices and/or systems. In some examples, computing system 200 may be, or may be part of, any component, device, or system that includes a processor or other suitable computing environment for processing information or executing software instructions and that operates in accordance with one or more aspects of the present disclosure. In some examples, computing system 200 may be fully implemented as hardware in one or more devices or logic elements.

In the example of FIG. 2, computing system 200 may include one or more processors 210, one or more communication units 212, one or more input/output devices 214, and one or more storage devices 216. One or more of the devices, modules, storage areas, or other components of computing system 200 may be interconnected to enable inter-component communications (physically, communicatively, and/or operatively). In some examples, such connectivity may be provided by through communication channels, a system bus, a network connection, an inter-process communication data structure, or any other method for communicating data. A power source (not shown) may provide power to one or more components of computing system 200. In some examples, the power source may receive power from the primary alternative current (AC) power supply in a commercial building or data center, where some or all of an enterprise network may reside. In other examples, the power source may be or may include a battery.

One or more processors 210 of computing system 200 may implement functionality and/or execute instructions associated with computing system 200 associated with one or more modules illustrated herein and/or described below. One or more processors 210 may be, may be part of, and/or may include processing circuitry that performs operations in accordance with one or more aspects of the present disclosure. Examples of processors 210 include microprocessors, application processors, display controllers, auxiliary processors, one or more sensor hubs, and any other hardware configured to function as a processor, a processing unit, or a processing device. Computing system 200 may use one or more processors 210 to perform operations in accordance with one or more aspects of the present disclosure using software, hardware, firmware, or a mixture of hardware, software, and firmware residing in and/or executing at computing system 200.

One or more communication units 212 of computing system 200 may communicate with devices external to computing system 200 by transmitting and/or receiving data, and may operate, in some respects, as both an input device and an output device. In some examples, communication units 212 may communicate with other devices over a network. In other examples, communication units 212 may send and/or receive radio signals on a radio network such as a cellular radio network. In other examples, communication units 212 of computing system 200 may transmit and/or receive satellite signals on a satellite network such as a Global Positioning System (GPS) network. Examples of communication units 212 include a network interface card (e.g., such as an Ethernet card), an optical transceiver, a radio frequency transceiver, a GPS receiver, or any other type of device that may send and/or receive information. Other examples of communication units 212 may include devices capable of communicating over Bluetooth®, GPS, near field communication (NFC), ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input/output devices 214 may represent any input or output devices of computing system 200 not otherwise separately described herein. One or more input/output devices 214 may generate, receive, and/or process input from any type of device capable of detecting input from a human or machine. One or more input/output devices 214 may generate, present, and/or process output through any type of device capable of producing output.

One or more storage devices 216 within computing system 200 may store information for processing during operation of computing system 200. Storage devices 216 may store program instructions and/or data associated with one or more of the modules described in accordance with one or more aspects of this disclosure. One or more processors 210 and one or more storage devices 216 may provide an operating environment or platform for such modules, which may be implemented as software, but may in some examples include any combination of hardware, firmware, and software. One or more processors 210 may execute instructions and one or more storage devices 216 may store instructions and/or data of one or more modules. The combination of processors 210 and storage devices 216 may retrieve, store, and/or execute the instructions and/or data of one or more applications, modules, or software. Processors 210 and/or storage devices 216 may also be operably coupled to one or more other software and/or hardware components, including, but not limited to, one or more of the components of computing system 200.

In some examples, one or more storage devices 216 are temporary memories, meaning that a primary purpose of the one or more storage devices is not long-term storage. Storage devices 216 of computing system 200 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Storage devices 216, in some examples, also include one or more computer-readable storage media. Storage devices 216 may be configured to store larger amounts of information than volatile memory. Storage devices 216 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. In accordance with the disclosed techniques, storage devices 216 may store modules including data tracker and collection module 218, feature extraction module 220, machine learning model(s) 222 and machine learning model update module 223.

Data tracker and collection module 218 may obtain data associated with a current state of a current loan on a secured property of a user from data repositories in a number of systems, both internal to the same enterprise network or institution as computing system 200 and external to the enterprise network or institution of computing system 200. Data tracker and collection module 218 may use a unique global user identifier for the user and associate this unique global user identifier with multiple local user identifiers used at multiple data repositories from which data is obtained. Data tracker and collection module 218 may obtain the data on a fixed, periodic schedule, such as once a day, week or month.

The data may include details concerning the user and the user's relationship with the institution as well as details concerning a secured property, such as the address of the secured property, the current loan amount, the current loan interest rate. The data concerning the user's relationship to the institution may include additional properties, additional loans, creditworthiness, length of relationship with the institution, and account information such as savings and checking accounts. The data may also include property value estimates and general interest rate related information, such as prime rates, federal funds rates, or costs of funds.

Feature extraction module 220 at computing system 200 may process the data for use by data models, such as machine learning models 222 in the refinance offer module 211. Feature extraction module 220 may transform the data into features used for the training and operation of machine learning models 222.

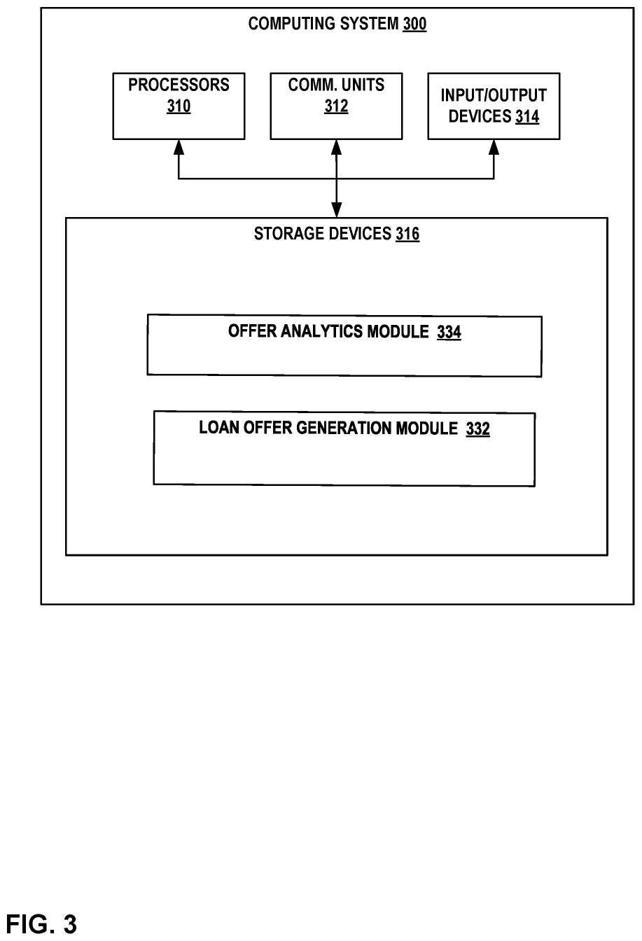

Machine learning models 222 may produce predicted values and associated confidence scores. The confidence scores may indicate the level of certainty or trust that a data model has in its predictions or classifications. Predicted values determined by one or more of machine learning models 222 may include a predicted refinance rate for the secured property. Machine learning models 222 may also determine a confidence score that the predicted refinance rate is accurate. Other outputs of the one or more machine learning models 222 may include a predicted risk and an associated risk confidence score that the predicted risk is accurate, and a predicted refinanced loan amount and an associated refinanced loan amount confidence score that the predicted refinanced loan amount is accurate. Computing system 200 may provide the predicted values and confidence scores to computing system 300, discussed below with respect to FIG. 3, to determine whether to present an offer for a refinanced loan on the secured property at the predicted refinance rate to the user and generate a message indicating the offer.

Machine learning model update module 223 may update the one or more machine learning models 222 based on the user response to the offer for the refinanced loan. For example, machine learning model update module 223 may retrain parameters of machine learning models 222 based on the user response to the refinanced loan offer. Computing system 200 may also obtain web analytics related to the user interaction with the message and machine learning model update module 223 may update the machine learning models 222 based on the web analytics.

Modules illustrated in FIG. 2 (i.e., data tracker and collection module 218, feature extraction module 220, machine learning model(s) 222, and machine learning model update module 223) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on the underlying hardware. One or more of such modules may execute as one or more services of an operating system or computing platform. One or more of such modules may execute as one or more executable programs at an application layer of a computing platform. In other examples, the functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIG. 3 is a block diagram illustrating an example computing system 300 configured to generate offers for refinanced loans on secured properties, in accordance with one or more aspects of the present disclosure. Computing system 300 may generally correspond to computing system 104 of FIG. 1. Accordingly, Computing system 300 may perform some or all of the same functions described in connection with FIG. 1 as being performed by computing system 104.

Computing system 300 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 300 may comprise a server within a data center, cloud computing system, server farm, and/or server cluster (or portion thereof) that provides services to client devices and other devices or systems. For example, computing system 300 may host or provide access to services provided by one or more applications and/or modules running on computing system 300.

Although computing system 300 of FIG. 3 is illustrated as a stand-alone device, in other examples computing system 300 may be implemented in any of a wide variety of ways, and may be implemented using multiple devices and/or systems. In some examples, computing system 300 may be, or may be part of, any component, device, or system that includes a processor or other suitable computing environment for processing information or executing software instructions and that operates in accordance with one or more aspects of the present disclosure. In some examples, computing system 300 may be fully implemented as hardware in one or more devices or logic elements.

In the example of FIG. 3, computing system 300 may include one or more processors 310, one or more communication units 312, one or more input/output devices 314, and one or more storage devices 316 which may operate in a similar fashion to one or more processors 210, one or more communication units 212, one or more input/output devices 214, and one or more storage devices 216 discussed with respect to FIG. 2 above. In accordance with the disclosed techniques, storage devices 316 may store modules including offer analytics module 334 and offer generation module 332.

Offer analytics module 334 at computing system 300 may determine whether to present an offer for a refinanced loan on the secured property at the predicted refinance rate to the user based on the predicted values and confidence scores. Offer analytics module 334 may use the associated confidence score and a determination of an advantage of the refinanced loan over the current loan on the secured property. For example, if the predicted refinance rate is less than the current interest rate on the secured property by a threshold amount, offer analytics module 334 may determine to present an offer for the refinanced loan to the user. In some examples, offer analytics module 334 may also use a predicted risk and/or a predicted refinance loan amount for the refinanced loan at the predicted refinance rate to determine the advantage of the refinanced loan over the current loan on the secured property.

Offer analytics module 334 may analyze the output of machine learning models 222 of computing system 200. Offer analytics module 334 may use rules with thresholds with respect to the predicted values and confidence scores to determine whether to provide a refinance offer to the user. If the rules are satisfied, offer analytics module 334 may determine to send a refinance offer to a user. Computing system 300 may update or refine the thresholds or other rules based on the user response to the offer for the refinanced loan. For example, offer analytics module 334 may refine thresholds based on the user response to the refinanced loan offer to avoid presenting offers that tend to be rejected by users. Computing system 300 may also obtain web analytics related to the user interaction with the message and offer analytics module 334 may update or refine the thresholds or other rules based on the web analytics.

Offer generation module 332 may, based on a determination to present the offer for the refinanced loan to the user, generate and send a message including an indication of the offer for the refinanced loan with the predicted refinance rate to a user device. The generated message may also include indications of any offer restrictions associated with the secured property and the predicted refinance rate, which the user must fulfill in order to be eligible for the refinanced loan at the predicted refinance rate.

Modules illustrated in FIG. 3 (i.e., offer analytics module 334 and loan offer generation module 332) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on the underlying hardware. One or more of such modules may execute as one or more services of an operating system or computing platform. One or more of such modules may execute as one or more executable programs at an application layer of a computing platform. In other examples, the functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

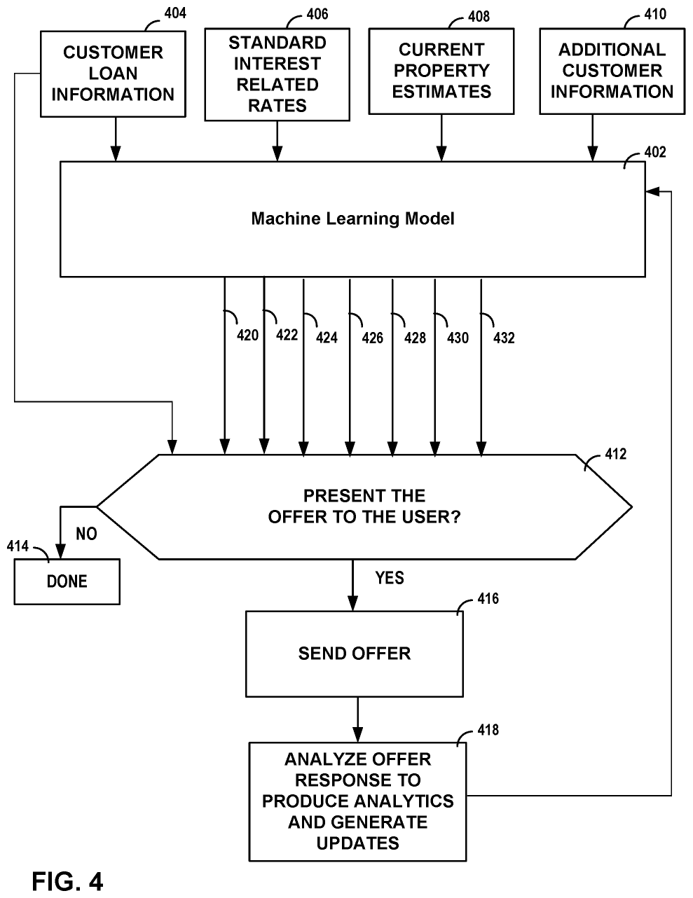

FIG. 4 is a conceptual diagram illustrating an example operation of predicting refinance rates for secured properties using machine learning models and generating offers for refinanced loans on the secured properties, in accordance with one or more aspects of the present disclosure. A variety of data may be used as input to machine learning model 402 configured to determine a predicted refinance rate. Customer loan information 404 may include information concerning a current customer's loan such as address, current loan amount, current interest rate and other information. Standard interest related rates 406 may include interest rates and or costs of funds information. For example, a federal funds rate or prime rate may be a base interest rate for determining a predicted interest rate. In one example, a data model may produce a delta which may be added to the federal funds rate or prime rate to produce the predicted interest rate.

Property estimates 408 may include an estimate of the current property value for a secured property. The system, such as computing system 102 of FIG. 1, may obtain such property value estimates from a property value tracker 130 of computing system 106 of FIG. 1. Additional customer information 410 may include information related to the customer and the customer's relationship with the institution. For example, the system may use information about any additional loans, the duration of the relationship between the user and the institution, credit scores and other information.

The system, such as computing system 102 of FIG. 1, may train machine learning model 402 using training data. Output of the machine learning model 402 may include predicted refinance interest rates 420, predicted loan amount 422 and a predicted risk value 424. The predicted refinance interest rate 420 is the predicted interest rate for a refinanced loan, the predicted loan amount 422 is the predicted monetary amount of a refinanced loan that the financial or lending institution would offer at the predicted refinance rate, and the predicted risk value 424 is an indication of how risky a refinanced loan at the predicted refinance rate would be for the financial or lending institution. In addition to these values, machine learning model 402 may produce associated confidence scores that the respective predicted values are accurate. The confidence scores may include a confidence score 426 for the predicted refinance interest rate 420, a confidence score 428 for the predicted loan amount 422, and a confidence score 430 for the predicted risk value 424.

Machine learning model 402 may also produce offer restrictions 432 associated with the predicted refinance rate for the secured property and any subsequent offer for a refinanced loan on the secured property at the predicted refinance rate. For example, offer restrictions 432 may include certain requirement with which the user must comply in order to qualify for the refinanced loan at the predicted refinance rate.

The system, such as computing system 104 of FIG. 1, may use the output 420, 422, 424, 426, 428, 430, 432 of machine learning model 402 and threshold values or other rules to determine whether to present an offer for a refinanced loan on the secured property at the predicted refinance rate to a user (412). If the offer for the refinanced loan would not be advantages over the current loan on the secured property (NO branch of 412), then the operation ends with no refinance offer being presented for the secured property at that time (414). If the refinanced loan would be advantages over the current loan on the secured property (YES branch of 412), the system, such as computing system 104 of FIG. 1, sends a message indicating the offer for the refinanced loan with the predicted refinance rate to the user (416). The system, such as computing systems 102, 104 of FIG. 1, may analyze the user's response to the offer to produce analytics and generate updates to machine learning model 402 and/or the thresholds or other rules used to determine whether to present the offer (418). For example, parameters of machine learning model 402 may be retrained based on user response data.

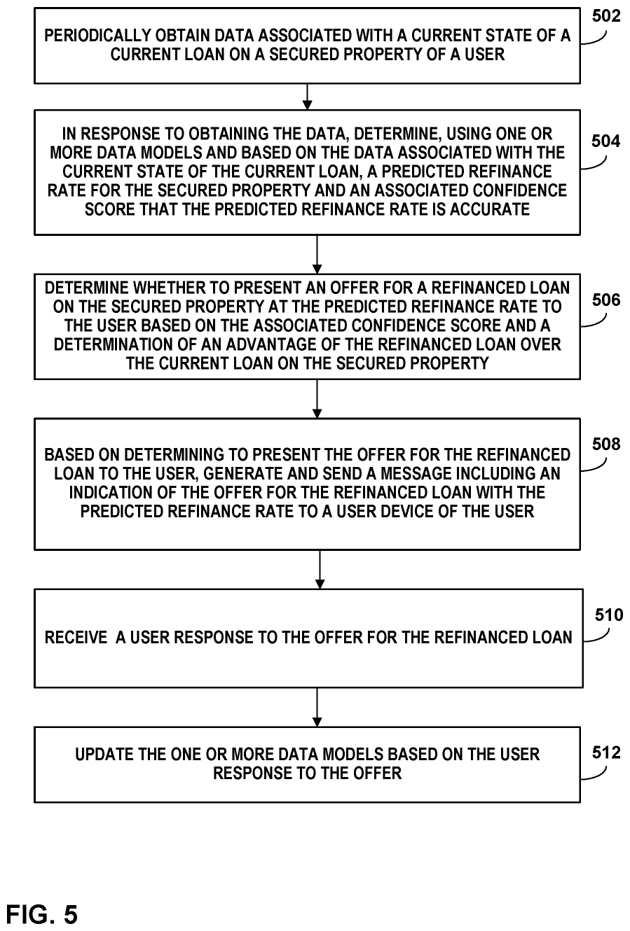

FIG. 5 is a flow diagram illustrating an example operation of proactively generating refinance offers for secured properties, in accordance with one or more aspects of the present disclosure. The operations of FIG. 5 are described within the context of computing system 102 and computing system 104 from FIG. 1. In other examples, operations described in FIG. 5 may be performed by computing system 200 of FIG. 2 and computing system 300 of FIG. 3, or one or more other components, modules, systems, or devices. Further, in other examples, operations described in connection with FIG. 5 may be merged, performed in a different sequence, or omitted.

Computing system 102 may periodically obtain data associated with a current state of a current loan on a secured property of a user (502). The data may include data internal to the institution as well as external data such as property value estimates. Computing system 102 may, in response to obtaining the data, determine, using one or more data models and based on the data associated with the current state of the current loan, a predicted refinance rate for the secured property and an associated confidence score that the predicted refinance rate is accurate (504). The data models may be machine learning models trained using historical information. Computing system 104 may determine whether to present an offer for a refinanced loan on the secured property at the predicted refinance rate to the user based on the associated confidence score and a determination of an advantage of the refinanced loan over the current loan on the secured property (506). For example, the determination of the advantage may include determining that the predicted interest rate is better than the current interest rate by a threshold amount.

Computing system 104 may, based on determining to present the offer for the refinanced loan to the user, generate and send a message including an indication of the offer for the refinanced loan with the predicted refinance rate to a user device of the user (508). The message may be included in an email, text message or within an app or website. Computing system 102 or 104 may receive a user response to the offer for the refinanced loan (510). The response may be an acceptance or rejection of the offer. Computing system 102 or 104 may update the one or more data models based on the user response to the offer (512). For example, the parameters of a machine learning model may be retrained using user responses so that future offers are more accurate and desirable to users.

Applications and modules illustrated in FIG. 5 and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on the underlying hardware. One or more of such modules may execute as one or more services of an operating system or computing platform. One or more of such modules may execute as one or more executable programs at an application layer of a computing platform. In other examples, the functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

By way of example and not limitation, such computer-readable storage media may include RAM, ROM, EEPROM, CD-ROM, or other optical disk storage, magnetic disk storage, or other magnetic storage devices, flash memory, cache memory, or any other medium that can be used to store desired program code in the form of instructions or store data structures and that can be accessed by a computer. Also, any connection is a properly termed a computer-readable medium. For example, if instructions are transmitted from a website, server, or other remote source using a coaxial cable, fiber optic cable, twisted pair, digital subscriber line (DSL), or other wireless technologies such as infrared, radio, and microwave, then the coaxial cable, fiber optic cable, twisted pair, DSL, or other wireless technologies such as infrared, radio, and microwave are included in the definition of medium. It should be understood, however, that computer-readable storage media and data storage media do not include connections, carrier waves, signals, or other transient media, but are directed to non-transient, tangible storage media. Disk and disc, as used herein, includes compact disk (CD), laser disc, optical disc, digital versatile disc (DVD), and Blu-ray disc, where disks usually reproduce data magnetically, while discs reproduce data optically with lasers. Combinations of the above should be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor”, as used herein may refer to any of the foregoing structure of any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, software systems, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A method comprising:
periodically obtaining, by a computing system, data associated with a current state of a current loan on a secured property of a user;
in response to obtaining the data, determining, by the computing system using one or more data models and based on the data associated with the current state of the current loan, a predicted refinance rate for the secured property and an associated confidence score that the predicted refinance rate is accurate;
determining whether to present an offer for a refinanced loan on the secured property at the predicted refinance rate to the user based on the associated confidence score and a determination of an advantage of the refinanced loan over the current loan on the secured property;
based on determining to present the offer for the refinanced loan to the user, generating and sending a message including an indication of the offer for the refinanced loan with the predicted refinance rate to a user device of the user;
receiving a user response to the offer for the refinanced loan; and
updating the one or more data models based on the user response to the offer.

2. The method of claim 1, wherein the one or more data models includes a machine learning model and wherein updating the one or more data models includes retraining parameters of the machine learning model based on the user response to the offer for the refinanced loan.

3. The method of claim 1, further comprising:
generating a unique global user identifier for the user and associating the unique global user identifier with local user identifiers used at multiple data repositories;
receiving the data associated with a current state of a current loan from the multiple data repositories,
associating and storing the data relevant to the offer for the refinanced loan with the user using the unique global user identifier, wherein generating the offer for the refinanced loan includes using the unique global user identifier to determine data to provide to the one or more data models.

4. The method of claim 1, further comprising labeling data for offers as accepted or rejected to produce labeled data, and wherein updating the one or more data models is based on the labeled data.

5. The method of claim 1, further comprising obtaining information related to a user interaction with the message at a web page and wherein the updating of the one or more data models is further based on the information related to a user interaction with the message at a web page.

6. The method of claim 1, wherein determining whether to present the offer for the refinanced loan to the user comprises transmitting the predicted refinance rate and the associated confidence score to a second computing system configured to determine whether to present the offer for the refinanced loan to the user, wherein the second computing system is configured to generate and approve the refinanced loan in accordance with the offer.

7. The method of claim 6, wherein the second computing system enables an administrator to authorize the offer for the refinanced loan.

8. The method of claim 1, wherein the offer for the refinanced loan includes an offer restriction which the user must fulfill before the offer for the refinanced loan is valid.

9. The method of claim 1, further comprising determining, by the computing system using the one or more data models and based on the data associated with the current state of the current loan, a predicted risk and an associated risk confidence score that the predicted risk is accurate, and wherein determining whether to present the offer for the refinanced loan is further based on the predicted risk and the associated risk confidence score.

10. The method of claim 1, further comprising determining, by the computing system using the one or more data models and based on the data associated with the current state of the current loan, a predicted refinanced loan amount and an associated refinanced loan amount confidence score that the predicted refinanced loan amount is accurate, and wherein determining whether to present the offer for the refinanced loan is further based on the predicted refinanced loan amount and the associated refinanced loan amount confidence score that the predicted refinanced loan amount is accurate.

11. The method of claim 1, further comprising:
periodically obtaining, by the computing system, additional data associated with current states of current loans on multiple additional secured properties;
in response to obtaining the additional data, determining, by the computing system using the one or more data models and based on the additional data, predicted refinance rates for the multiple additional secured properties and associated confidence scores that the predicted refinance rates are accurate;
determining whether to present one or more offers for refinanced loans on one or more of the multiple additional secured properties based on the associated confidence scores and a determination of an advantage of the refinanced loans over current loans on the one or more of the multiple additional secured properties; and
based on determining to present the one or more offers, generating and sending messages including the one or more offers.

12. A computing system comprising:
one or more memories; and
processing circuitry in communication with the one or more memories, the processing circuitry configured to:
periodically obtain data associated with a current state of a current loan on a secured property of a user;
in response to obtaining the data, determine, using one or more data models and based on the data associated with the current state of the current loan, a predicted refinance rate for the secured property and an associated confidence score that the predicted refinance rate is accurate;
determine whether to present an offer for a refinanced loan on the secured property at the predicted refinance rate to the user based on the associated confidence score and a determination of an advantage of the refinanced loan over the current loan on the secured property;
based on determining to present the offer for the refinanced loan to the user, generate and send a message including an indication of the offer for the refinanced loan with the predicted refinance rate to a user device of the user;
receive a user response to the offer for the refinanced loan; and
update the one or more data models based on the user response to the offer.

13. The computing system of claim 12, wherein the one or more data models includes a machine learning model and wherein updating the one or more data models includes retraining parameters of the machine learning model based on the user response to the offer for the refinanced loan.

14. The computing system of claim 12, wherein the processing circuitry is further configured to:
generate a unique global user identifier for the user and associating the unique global user identifier with local user identifiers used at multiple data repositories;
receive the data relevant to the offer for the refinanced loan from the multiple data repositories, and
associate and store the data relevant to the offer for the refinanced loan with the user using the unique global user identifier, wherein to generate the offer for the refinanced loan the processing circuitry uses the unique global user identifier to determine data to provide to the one or more data models.

15. The computing system of claim 12, wherein the processing circuitry is configured to label data for offers as accepted or rejected to produce labeled data, and wherein to updating the one or more data models is based on the labeled data.

16. The computing system of claim 12, wherein the computing system provides the predicted refinance rate and the associated confidence score to a second computing system that determines whether to present the offer for the refinanced loan to the user, the second computing system generating and approving the refinanced loan in accordance with the offer.

17. The computing system of claim 12, wherein the processing circuitry is further configured to produce, using the one or more data models and based on the data associated with the current state of the current loan, a predicted risk and an associated risk confidence score that the predicted risk is accurate and wherein the processing circuitry determines whether to present the offer for the refinanced loan further based on the predicted risk and the associated risk confidence score.

18. The computing system of claim 12, wherein the processing circuitry is further configured to produce, using the one or more data models and based on the data associated with the current state of the current loan, a predicted refinanced loan amount and an associated refinanced loan amount confidence score that the predicted refinanced loan amount is accurate and wherein the processing circuitry determines whether to present the offer for the refinanced loan further based on the predicted refinanced loan amount and the associated refinanced loan amount confidence score.

19. The computing system of claim 12, wherein the processing circuitry is further configured to:
periodically obtain additional data associated with current states of current loans on multiple additional secured properties;
in response to obtaining the additional data, determine, using one or more data models and based on the additional data, predicted refinance rates for the multiple additional secured properties and associated confidence scores that the predicted refinance rates are accurate;
determine whether to present one or more offers for refinanced loans on one or more of the multiple additional secured properties based on the associated confidence scores and a determination of an advantage of the refinanced loans over current loans on the one or more of the multiple additional secured properties;
based on determining to present the one or more offers, generate and send messages including the one or more offers.

20. A non-transitory computer-readable storage medium comprising instructions that, when executed, cause processing circuitry to:
periodically obtain data associated with a current state of a current loan on a secured property of a user;
in response to obtaining the data, determine, using one or more data models and based on the data associated with the current state of the current loan, a predicted refinance rate for the secured property and an associated confidence score that the predicted refinance rate is accurate;
determine whether to present an offer for a refinanced loan on the secured property at the predicted refinance rate to the user based on the associated confidence score and a determination of an advantage of the refinanced loan over the current loan on the secured property;
based on determining to present the offer for the refinanced loan to the user, generate and send a message including an indication of the offer for the refinanced loan with the predicted refinance rate to a user device of the user;
receive a user response to the offer for the refinanced loan; and
update the one or more data models based on the user response to the offer.
